(19) United States
(12) Patent Application Publication
(10) Pub. No.: US 2026/0061459 A1
(43) Pub. Date: Mar. 5, 2026

(54) NON-CONTACT TACTILE SENSE PRESENTATION DEVICE AND NON-CONTACT TACTILE SENSE PRESENTATION SYSTEM

(71) Applicants: Yuki TAKAHASHI, Tokyo (JP); Takayuki NUMAKUNAI, Tokyo (JP); Chikara SEKIGUCHI, Tokyo (JP); Takayuki MATSUSHIMA, Tokyo (JP)

(72) Inventors: Yuki TAKAHASHI, Tokyo (JP); Takayuki NUMAKUNAI, Tokyo (JP); Chikara SEKIGUCHI, Tokyo (JP); Takayuki MATSUSHIMA, Tokyo (JP)

(73) Assignee: MINEBEA MITSUMI Inc., Nagano (JP)

(21) Appl. No.: 19/101,698

(22) PCT Filed: Aug. 8, 2023
(86) PCT No.: PCT/JP2023/028876

§ 371 Date: Feb. 6, 2025

(30) Foreign Application Priority Data
Aug. 9, 2022 (JP) 2022-127460

(51) Int. Cl. B06B 1/04; H02K 33/16

(52) U.S. Cl. CPC B06B 1/045; H02K 33/16

(57) ABSTRACT

Provided is a non-contact tactile sense presentation device including: a movable body having a magnet; an elastic part that supports the movable body so as to freely vibrate; a fixed body that generates a magnetic field when a current at a frequency equal to the resonance frequency of the movable body is supplied thereto and that has a coil for vibrating the movable body due to electromagnetic interaction with the magnet; and a fluid discharge part that has a chamber portion, which stores a fluid therein and which has a diaphragm that allows the fluid in the chamber portion to come out and come in according to deformation of the diaphragm caused by a resonant vibration of the movable body, and that presents a tactile sense by means of the fluid coming out from the chamber portion.

### TECHNICAL FIELD

The present invention relates to a non-contact tactile presentation apparatus that presents an output perceptible as a tactile sensation to a user without contact, and a non-contact tactile presentation system using the same.

### BACKGROUND ART

As a related art, a tactile presentation apparatus that applies vibration to a touch panel by an actuator is known as one of techniques for feeding back an operational feeling (tactile sensation) of a contact operation to a finger pad or the like of a user touching the touch panel (see PTL 1).

For example, PTL 1 includes an operation detection part that detects the amount of operation on the operation surface of a panel; an actuator that gives vibration to the operation surface; and a control part that controls and drives the actuator based on the results of the operation detection part.

### CITATION LIST

### Patent Literature

PTL 1

Japanese Patent Application Laid-Open No. 2020-071674

### SUMMARY OF INVENTION

### Technical Problem

For an operation apparatus such as a touch panel is operated, an unspecified number of people may operate the touch panel. In this case, however, if a virus or dirt is attached to the surface of the touch panel, virus infection or the like may spread.

The contact can be avoided in a case where the device includes a sensor that detects non-contact, but in a case the means for notifying the completion of the operation is limited to screen display or sound, resulting in a lack of variation in the operation feeling provided as a tactile sensation.

An object of the present invention is to provide a non-contact tactile presentation apparatus and a non-contact tactile presentation system that present a non-contact tactile sensation with a suitable operation feeling to a user without contaminating the fingers.

### Solution to Problem

A non-contact tactile presentation apparatus according to an aspect of the present disclosure includes: a movable body including a magnet; an elastic part configured to support the movable body in a manner allowing vibration; a fixed body including a coil configured to vibrate the movable body through an electromagnetic interaction with the magnet by generating a magnetic field with a supply of a current of a frequency equal to a resonance frequency of the movable body; and a fluid ejection part including a chamber part including a diaphragm and configured to store inside a fluid, the fluid ejection part being configured to present a tactile sensation using the fluid ejected from the chamber part by taking in and out the fluid in the chamber part in accordance with deformation of the diaphragm accompanying resonance vibration of the movable body.

A non-contact tactile presentation apparatus according to an aspect of the present disclosure includes: a movable body including a magnet; an elastic part configured to support the movable body in a manner allowing vibration; a fixed body including a coil configured to vibrate the movable body through an electromagnetic interaction with the magnet by generating a magnetic field with a supply of a current of a frequency close to a resonance frequency of the movable body; and a fluid ejection part including a chamber part including a diaphragm and configured to store inside a fluid, the fluid ejection part being configured to present a tactile sensation using the fluid ejected from the chamber part by taking in and out the fluid in the chamber part in accordance with deformation of the diaphragm accompanying vibration of the movable body.

A non-contact tactile presentation system according to an aspect of the present disclosure includes: the above-described non-contact tactile presentation apparatus; an operation apparatus including an operation part configured to detect a non-contact operation of a user; a control part configured to vibrate the movable body by energizing the coil in response to a detected non-contact operation; and an ejection hole provided in the operation apparatus and configured to eject toward the user a fluid output from the chamber part.

### Advantageous Effects of Invention

According to the present invention, it is possible to realize an actuator and a system that present a non-contact tactile sensation with a suitable operation feeling to a user without contaminating the fingers.

### BRIEF DESCRIPTION OF DRAWINGS

FIG. 1 is an external perspective view of an actuator, which is an example of a non-contact tactile presentation apparatus according to Embodiment 1 of the present invention;

FIG. 2 is a longitudinal cross-sectional view illustrating a main part configuration of the actuator;

FIG. 3 illustrates the internal structure of the actuator with the case thereof removed;

FIG. 4 is an exploded perspective view of the actuator;

FIG. 5 is a perspective view of a drive unit;

FIG. 6 is a longitudinal cross-sectional view of a state in which the drive unit is accommodated in the case main body;

FIG. 7A is a perspective view illustrating a configuration of an upper edge part of an ejection wall part in an actuator, and FIG. 7B is an enlarged view of a X portion in FIG. 7A;

FIG. 8 is a cross-sectional view illustrating the configuration of the X portion in FIG. 7;

FIG. 9 is a diagram for describing an operation of an actuator, which is an example of the non-contact tactile presentation apparatus according to Embodiment 1 of the present invention;

FIG. 10A is a cross-sectional view of the actuator in a state where the movable body has moved to the bottom part side with the maximum amplitude and ejected the fluid, and FIG. 10B is a diagram illustrating the supply voltage in the same state;

FIG. 11A is a cross-sectional view of the actuator in a state where the movable body has moved to the maximum amplitude on the top surface side and ejected the fluid, and FIG. 11B is a diagram illustrating the supply voltage in the same state.

FIG. 12 is a diagram illustrating the relationship between the resonance frequency of the current supplied to the coil of the actuator and the velocity of the fluid ejected from the fluid ejection part;

FIG. 13 is a perspective view illustrating a variation of the actuator;

FIG. 14 is a longitudinal cross-sectional view illustrating a main part configuration of a variation of the actuator;

FIG. 15 is a partially exploded view illustrating a main part configuration of a fluid ejection part in a variation of the actuator;

FIG. 16 is an exploded view of a variation of the actuator; and

FIG. 17 is a schematic diagram illustrating a main part configuration of a non-contact tactile presentation system including the actuator.

Hereinafter, embodiments of the present invention will be described in detail with reference to the drawings.

### Overall Configuration of Actuator

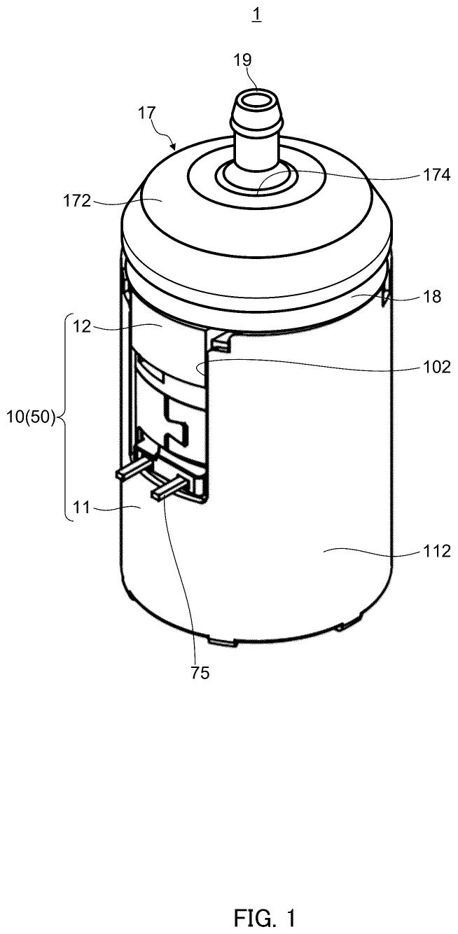

FIG. 1 is an external perspective view of an actuator, which is an example of a non-contact tactile presentation apparatus according to Embodiment 1 of the present invention, and

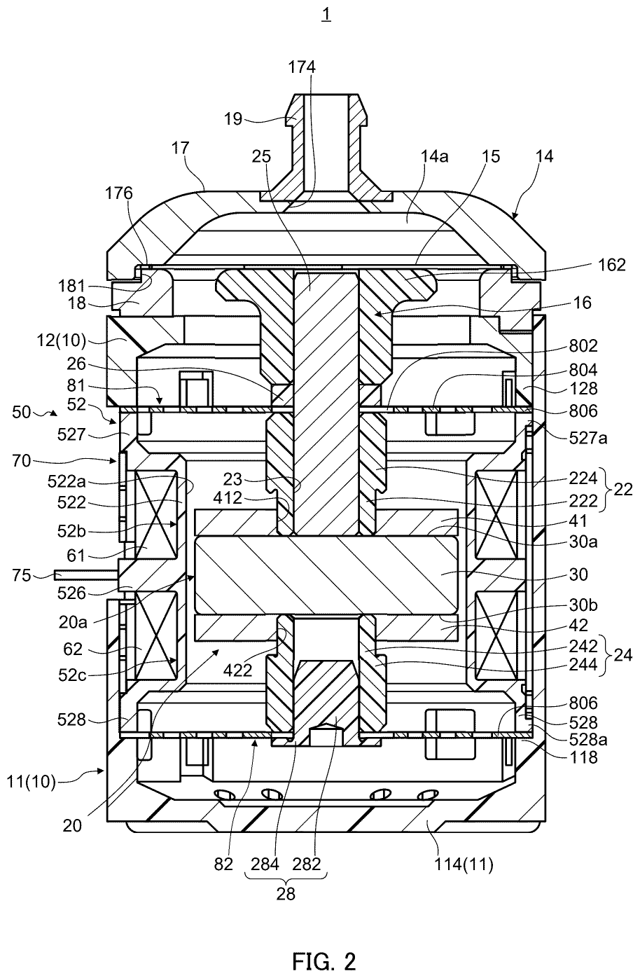

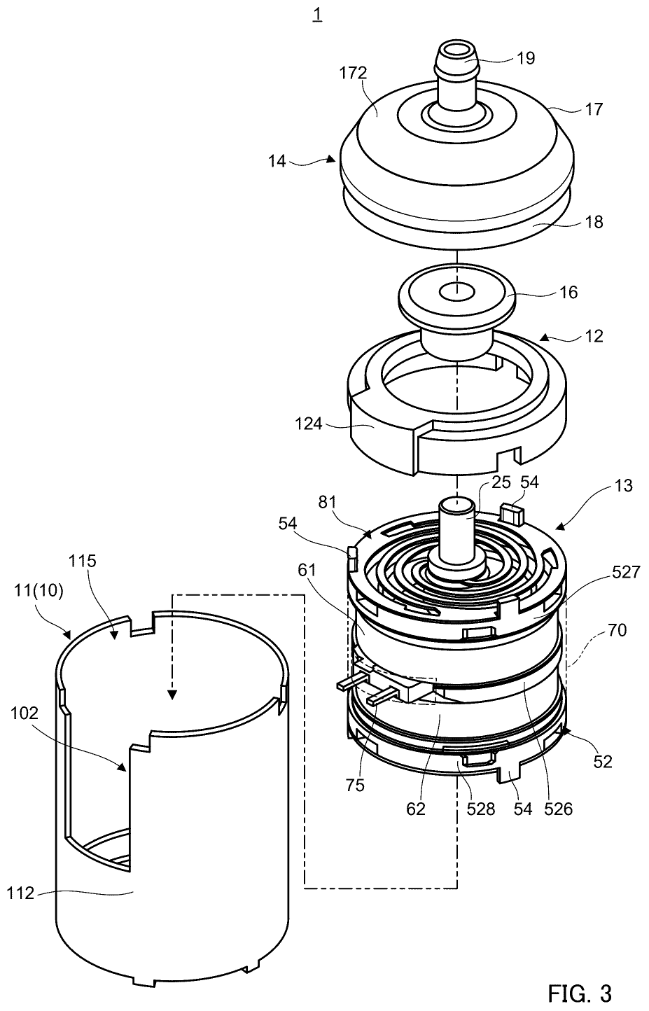

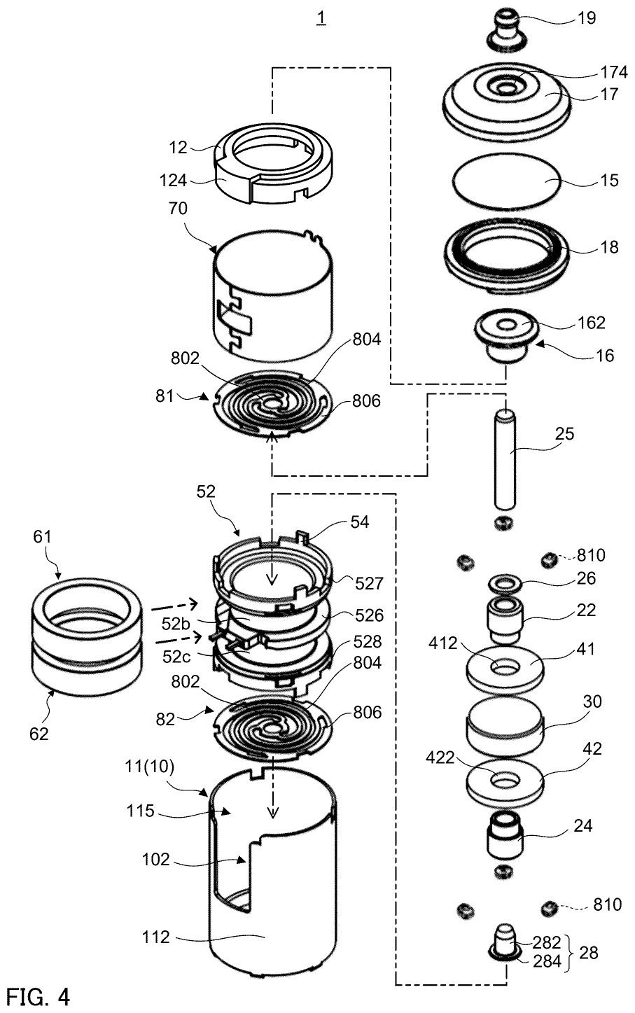

FIG. 2 is a longitudinal cross-sectional view illustrating a main part configuration of the actuator. FIG. 3 illustrates an internal structure of the actuator with the case thereof removed, and FIG. 4 is an exploded perspective view of the actuator.

The “upper” side and the “lower” side in the present embodiment are given for convenience to make it easier to understand, and respectively mean one side and the other side in the reciprocation direction of the movable body in the actuator. That is, when the actuator is mounted on an electronic apparatus (not illustrated), the actuator may be upside-down or left-right, but it is preferable that the back-and-forth direction of output shaft part 25 protruding in the actuator and the user's operation direction on the operation part are the same. This also applies to each embodiment described below.

Actuator (vibration actuator) 1 according to the present Embodiment 1 is preferably used as a device that provides aerial tactile feedback for operation detection in haptics, and the like. Actuator 1 is connected to an operation part (for example, a touch panel or the like) that is operated by a user in a non-contact manner, and drives movable body 20 in accordance with the movement of the movable body by the user's operation to present an output that is perceptible to the user.

Actuator 1 is, for example, an actuator that presents a tactile sensation to a user in a non-contact manner. Actuator 1 transmits, as a tactile sensation and a force sensation to the user, the ejection of fluid through the reciprocating motion of movable body 20 in response to a user's non-contact operation on the operation part. Further, actuator 1 may present the vibration accompanying the fluid ejection to the user as a sound to appeal to the user's sense of hearing. Further, actuator 1 may be implemented as a vibration generation source in an electronic apparatus such as a portable game terminal apparatus.

Note that as the non-contact tactile sensation in the present embodiment, a force sensation or the like as well as the tactile sensation is applied to the user at a predetermined amount, speed, or the like in the air with a fluid ejected through the movement or vibration of the movable body. For example, it may be referred to as aerial tactile feedback or aerial force feedback, which are functions used in haptics.

Actuator 1 of the present embodiment includes, as illustrated in FIGS. 1 and 2, drive unit 13 accommodated inside case 10 including case main body 11 and bracket 12, and fluid ejection part 14. Fluid ejection part 14 ejects fluid to the outside when drive unit 13 is driven.

Drive unit 13 is configured by connecting the main portion of fixed body 50 including coil holding part 52 and movable body 20 with elastic support parts 81 and 82.

Movable body 20 moves, i.e., vibrates, in the axial direction (up-down direction) of case 10 with respect to fixed body 50 within case 10.

Fluid ejection part 14 takes in and out the fluid with respect to chamber part 14a in accordance with the deformation of diaphragm 15 in response to the vibration of movable body 20 caused by the supply of a current with a frequency equal to the resonance frequency of movable body 20 to coils 61 and 62. Thus, the fluid ejected from chamber part 14a hits the user, thereby presenting a tactile sensation to the user.

Note that, since actuator 1 includes drive unit 13 in case 10, it is possible to highly accurately perform, in a process separate from case 10, assembly of the main portion by fixing movable body 20 to fixed body 50 via elastic support parts 81 and 82 in actuator 1.

In actuator 1, movable body 20 and fluid ejection part 14 are connected to each other via output shaft part 25 provided in movable body 20, and fluid is ejected through the movement of movable body 20.

Actuator 1 includes magnet 30 in movable body 20, and coils 61 and 62 in fixed body 50, and movable body 20 reciprocates in a straight line direction (axial direction) through the cooperation (electromagnetic interaction) between energized coils 61 and 62 and magnet 30.

In actuator 1, fluid ejection part 14 is formed together with a part of case 10, and movable body 20 is supported in a reciprocally movable manner with respect to fixed body 50 via elastic support parts 81 and 82 bridged between movable body 20 and fixed body 50 within case 10.

Specifically, in actuator 1, drive unit 13 includes output shaft part 25, magnet 30, a pair of yokes 41 and 42, and a pair of sleeves 22 and 24, and fixed body 50 includes a pair of annular coils 61 and 62 and outer yoke 70.

Although yokes 41 and 42, sleeves 22 and 24, and coils 61 and 62 are each provided in pairs, the configuration is not limited thereto, and each component may be composed of one part or three or more parts as long as movability in both directions in a straight line or in one direction can be achieved.

In actuator 1, coils 61 and 62, outer yoke 70, magnet 30, and yokes 41 and 42 constitute a magnetic circuit that moves movable body 20. In actuator 1, coils 61 and 62 are energized from a power supply part (not illustrated) via terminal part 75 to move movable body 20

### Movable Body 20

Movable body 20 can reciprocate in both directions in the axial direction that is a reciprocation direction, or in one direction that is one side in the axial direction.

Movable body 20 is disposed via elastic support parts 81 and 82 such that in a non-movable state its longitudinal center in the reciprocation direction is disposed to face the longitudinal center of coil holding part 52 in the reciprocation direction with a predetermined interval therebetween in the direction orthogonal to the axial direction of movable body 20. In the present embodiment, it is preferable that the longitudinal center of magnet 30 and yokes 41 and 42 in the reciprocation direction is located at a position facing, in the direction orthogonal to the reciprocation direction, the longitudinal center between upper and lower coils 61 and 62 separated in the reciprocation direction. Note that a magnetic fluid may be interposed between the inner peripheral surface of coil holding part 52 and movable body 20.

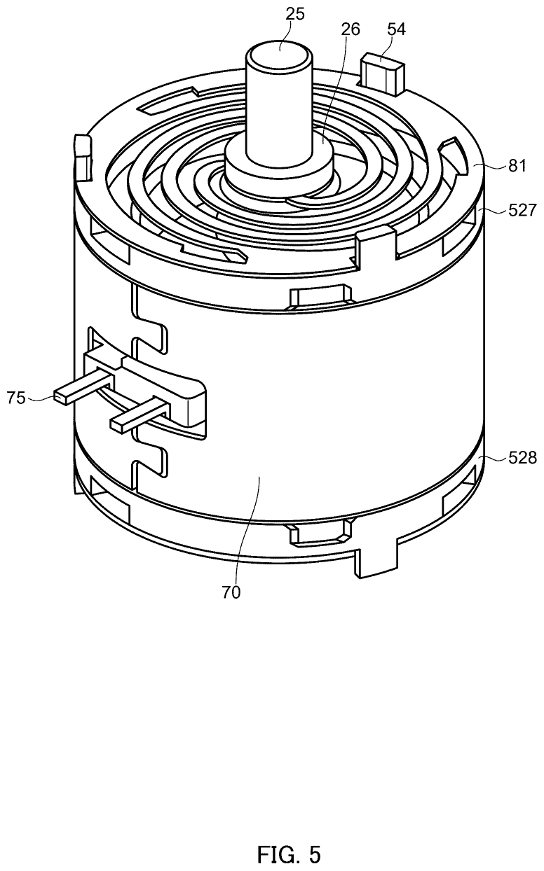

As illustrated in FIGS. 2 and 4 to 6, movable body 20 includes annular fixing part 26 and spring connection part 28, in addition to output shaft part 25, magnet 30, yokes 41 and 42, and sleeves 22 and 24.

Movable body 20 is provided with yokes 41 and 42, sleeves 22 and 24, annular fixing part 26, and spring connection part 28 in the bidirectional direction of the reciprocation direction with magnet 30 at the center. Specifically, movable body 20 is configured with yokes 41 and 42 stacked on front and back surfaces 30a and 30b of magnet 30, and elastic support parts 81 and 82 are engaged at the other end portions of sleeves 22 and 24, one end portions of which are engaged with opening parts 412 and 422 of yokes 41 and 42.

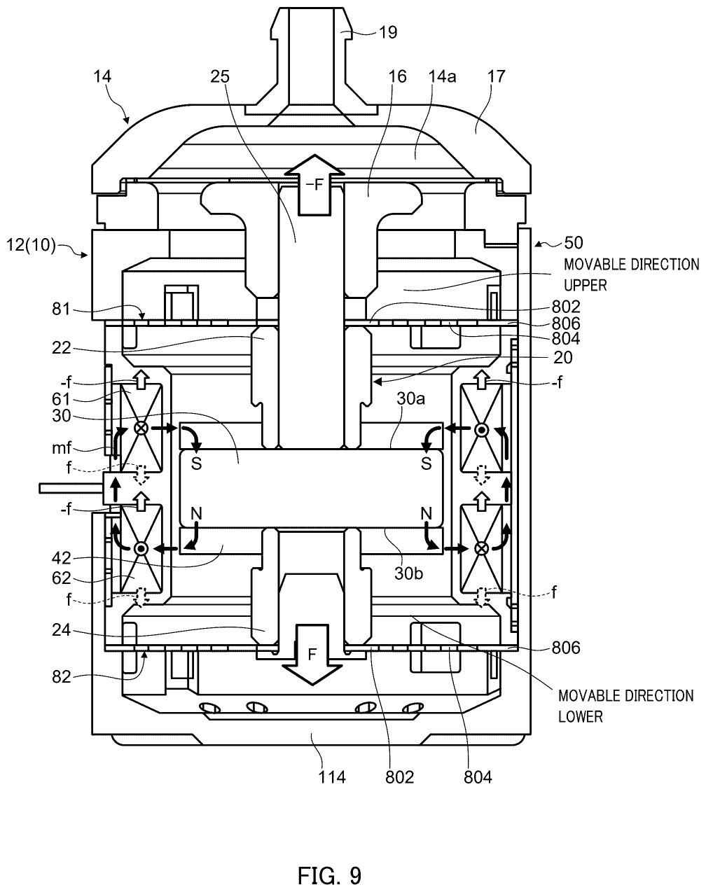

Note that, in movable body 20, flush outer peripheral surface 20a of magnet 30 and yokes 41 and 42 faces inner peripheral surface 522a of holding part main body 522 with a predetermined interval therebetween on the inner side of inner peripheral surface 522a. When movable body 20 moves in a reciprocating manner, outer peripheral surface 20a reciprocates along inner peripheral surface 522a without contacting the inner peripheral surface. Note that the reciprocation direction is the magnetization direction of magnet 30, and the axial direction of coil holding part 52, and the bidirectional direction (refer to arrow F and-F directions in FIG. 9) in the axial direction of coils 61 and 62.

Magnet 30 is solid and is magnetized in the reciprocation direction. Specifically, magnet 30 is disposed at a position surrounded by coils 61 and 62 in a separated manner. Magnet 30 is formed in a disk shape and has front and back surfaces 30a and 30b, which are separated from each other in the reciprocation direction (thickness direction), as magnetic pole surfaces with different polarities (for example, front surface 30a of an S pole and back surface 30b of an N pole).

Magnet 30 is disposed with a space from coils 61 and 62 (details will be described below) inside coils 61 and 62 in the radial direction. In other words, coils 61 and 62 are disposed on the outer side of magnet 30 in the radial direction with a gap therebetween. Herein, the “radial direction” is a direction orthogonal to the axes of coils 61 and 62, and also a direction orthogonal to the reciprocation direction. The “gap” in the radial direction is the gap between magnet 30 and coils 61 and 62 including holding part main body 522, and is a gap that allows movable body 20 to move in the reciprocation direction without contacting each other. That is, in the present embodiment, the term “gap” refers to a predetermined gap between holding part main body 522 and magnet 30.

In the present embodiment, magnet 30 is disposed to face the center of holding part main body 522 in the direction orthogonal to the axial direction at the center of the width of the outer peripheral surface on the radially outside. Magnet 30 may have any shape other than a disk shape, such as a cylindrical shape or a plate shape as long as magnet 30 is disposed inside coils 61 and 62 with the two magnetized surfaces facing the extending direction of the axes of coils 61 and 62, i.e., the reciprocation direction.

In the present embodiment, magnet 30 is a solid body, and thus unlike a cylindrical member, there is no need to process the opening, and the area of the front and back surfaces serving as magnetic pole surfaces is not reduced due to formation of the opening. In addition, it is desirable that the center of magnet 30 in the axial direction coincide with the center of movable body 20 in the axial direction. The magnetization direction of magnet 30 is parallel to the moving direction of movable body 20.

Yokes 41 and 42 are magnetic materials, and constitute a movable body side magnetic circuit together with magnet 30. Yokes 41 and 42 concentrate the magnetic flux of magnet 30 and efficiently carry it without leakage, thus effectively distributing the magnetic flux flowing between magnet 30 and coils 61 and 62.

In addition, yokes 41 and 42 have a function of fixing sleeves 22 and 24 in addition to a function as a part of the magnetic circuit. Further, in movable body 20, yokes 41 and 42 may have a function as a main body portion of movable body 20 and a function as a weight.

In the present embodiment, yokes 41 and 42 are formed in an annular flat plate shape with the same outer diameter as magnet 30. Yokes 41 and 42 are members with the same shape disposed with magnet 30 therebetween, but may be members with different shapes. Yokes 41 and 42 are attracted and fastened to magnet 30, and are also fixed to magnet 30 via a thermosetting adhesive such as an epoxy resin or an anaerobic adhesive, for example.

Openings 412 and 422 are provided in the central parts of yokes 41 and 42, respectively and extended through the yokes in the axial direction, i.e., the thickness direction. One ends of the upper and lower sleeves 22 and 24 are fit and fixed inside openings 412 and 422, respectively.

Opening parts 412 and 422 support sleeves 22 and 24 such that the respective axes of sleeves 22 and 24 (which coincide with the centers of elastic support parts 81 and 82) are positioned on the central axis of movable body 20. Opening parts 412 and 422 can adjust the degree of the opening in yokes 41 and 42, thereby adjusting the weight of movable body 20 and setting a suitable reciprocating output.

In the present embodiment, yokes 41 and 42 are located inside (radially inside) coils 61 and 62 so as to face coils 61 and 62 in the direction orthogonal to the axial direction of coils 61 and 62 when movable body 20 is not reciprocating.

In yokes 41 and 42, it is preferable that the height position of the upper surface of yoke 41 on the upper side (front surface side) of magnet 30 faces the center position of coil 61 on the upper side in the height direction (reciprocation direction). In addition, it is preferable that the height position of the lower surface of yoke 42 on the lower side (back surface side) of magnet 30 faces the center position of coil 62 on the lower side in the height direction (reciprocation direction).

Sleeves 22 and 24 have a function of fixing the movable-side magnetic circuit to elastic support parts 81 and 82, and also have a function as a weight of movable body 20. Sleeves 22 and 24, symmetrically provided with magnet 30 and yokes 41 and 42 therebetween, increase the reciprocating output of movable body 20. Note that, in the present embodiment, sleeves 22 and 24 are formed in the same shape for the purpose of reducing the manufacturing cost of the components. Details of sleeve 24 will be described mainly in the description of sleeve 22, with the corresponding reference numerals for sleeves such as sleeves 22 and 24 being described together in the description of the sleeve 22, and the description of sleeve 24 will be omitted.

In the present embodiment, sleeves 22 and 24 also function as the shaft of the movable body extending along the central axis of movable body 20, and are interposed between yokes 41 and 42 and elastic support parts 81 and 82.

Sleeves 22 and 24 include joining parts 222 and 242 and spring fixing parts 224 and 244. Joining parts 222 and 242 and spring fixing parts 224 and 244 are continuously provided in the reciprocation direction.

Sleeves 22 and 24 are cylindrical members and have through-hole 23 extending through the inside. The base end portion of output shaft part 25 is inserted into and firmly fixed to through-hole 23 of sleeve 22.

Joining parts 222 and 242 are cylindrical members disposed on the axis line of movable body 20, and are joined to yokes 41 and 42, respectively. Joining parts 222 and 242 are joined with one ends thereof inserted to and fit inside openings 412 and 422 of yokes 41 and 42, respectively. On the other hand, the other end portions of joining parts 222 and 242 are disposed to face away from each other with magnet 30 at the center, and constitute both end portions that are separated from each other in the movement direction of movable body 20. Elastic support parts 81 and 82, which will be described later, are joined to each other at the other end portions.

In the present embodiment, sleeves 22 and 24 are joined to yokes 41 and 42 by press-fitting, but this is not limitative. The sleeves may be joined by bonding with a thermosetting adhesive such as an epoxy resin or an anaerobic adhesive, for example. In addition, while joining parts 222 and 242 are cylindrical members in the present embodiment, the joining parts may be solid cylinders or rod-shaped members including a concave portion on the axis line.

Spring fixing part 224 is a cylindrical member protruding to the other side (upward) from joining part 222 in sleeve 22 and having a larger outer diameter than joining part 222. In spring fixing part 224, the joining surface, which is the tip end (upper end) surface, is disposed around output shaft part 25.

Output shaft part 25, connected to movable body 20, moves together with movable body 20 and outputs the motion of movable body 20 to the outside. Output shaft part 25 is disposed on the axis line of movable body 20, and the base end side is fitted inside sleeve 22 and fixed to movable body 20.

The base end portion of output shaft part 25 is disposed in contact with surface 30a of magnet 30. The tip end portion of output shaft part 25 is inserted through inner peripheral part 802, which is the end portion (the other end portion) on the inner diameter side of the upper-side leaf spring serving as elastic support part 81, and is fitted into piston 16 on the upper side of elastic support part 81. Output shaft part 25 is connected to diaphragm 15 via piston 16, and their axes are the same.

Output shaft part 25 is inserted through inner peripheral part 802 of elastic support part 81, and is clamped between spring fixing part 224 and annular fixing part 26 in a state of being in contact with the joining surface of spring fixing part 224. Thus, spring fixing part 224 is joined to elastic support part 81 around output shaft part 25.

As described above, output shaft part 25 is projected to movable body 20 in one direction of the movement direction of movable body 20 to the side opposite to magnet 30 with respect to elastic support part 81, and piston 16 is capable of moving back and forth in the axial direction.

On the other hand, spring fixing part (spring fixing part on the lower side) 244, which is disposed on the side opposite to spring fixing part 224 of sleeve 22 with magnet 30 therebetween, is joined to inner peripheral part 802, which is an end portion on the inner diameter side, in a lower-side leaf spring, which is elastic support part 82.

Spring fixing part 244 is a cylindrical member protruding to the other side (downward) from joining part 242 in sleeve 24 and having a larger outer diameter than joining part 242. In spring fixing part 244, inner peripheral part 802 of the lower leaf spring serving as elastic support part 82 is clamped together with second spring fixing part 28 inserted into a through hole opening at the joint surface in the state where inner peripheral part 802 is in contact with the joint surface, which is the tip end (lower end) surface of spring fixing part 244.

Specifically, with shaft-shaped insertion part 282 inserted in the through hole of spring fixing part 244, second spring fixing part 28 clamps inner peripheral part 802 of elastic support part 82 together with the joint surface of the spring fixing part 244 at flange 284, which is provided on the outer periphery of the base end portion of insertion part 282. In this manner, spring fixing part 244 and elastic support part 82 are joined.

Second spring fixing part 28 may be, for example, a rivet such as a blind rivet. In second spring fixing part 28, the shaft-shaped insertion part 282 is fixed in the through hole of spring fixing part 244 by press fitting such as caulking.

By only providing sleeves 22 and 24 on yokes 41 and 42 making up the movable body-side magnetic circuit, the upper-side leaf spring and the lower-side leaf spring, which are elastic support parts 81 and 82, can be easily assembled to movable body 20, thereby enhancing the assemblability.

Note that sleeves 22 and 24 may be made of a magnetic material, but desirably sleeves 22 and 24 are made of a non-magnetic material. In a case where sleeves 22 and 24 are made of a non-magnetic material, the magnetic flux from yoke 41 does not flow upward, and the magnetic flux from yoke 42 does not flow downward, and thus, the magnetic flux can be efficiently delivered to coils 61 and 62 side located on the outer peripheral side of yokes 41 and 42.

### Elastic Support Parts 81 and 82

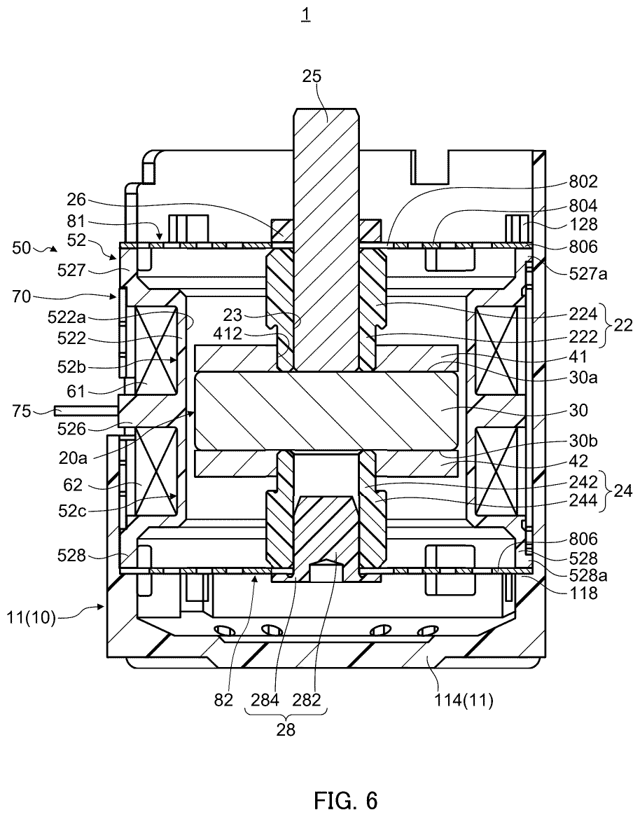

FIG. 6 is a longitudinal cross-sectional view of a state in which the drive unit is accommodated in the case main body. Elastic support parts 81 and 82 are disposed on both sides of movable body 20 in the movement direction in drive unit 13, and support movable body 20 in a movable manner in the movement direction with respect to coil holding part 52 of fixed body 50.

Elastic support parts 81 and 82, which are plate springs, are disposed with movable body 20 therebetween in the vibration direction of movable body 20, and bridged to movable body 20 and fixed body 50 in a direction intersecting the vibration direction.

Specifically, elastic support parts 81 and 82 are disposed over both ends (upper and lower ends) of movable body 20 separated from each other in the reciprocation direction, and the opening edges of fixed body 50 (coil holding part 52) disposed on the radially outside of the both ends. In the present embodiment, elastic support parts 81 and 82 are disposed along a direction orthogonal to the reciprocation direction and facing each other with movable body 20 therebetween in the reciprocation direction.

Elastic support parts 81 and 82 may be a non-magnetic material or a magnetic material (specifically, a ferromagnetic material). In a case where elastic support parts are non-magnetic plate springs, stainless steel plates such as SUS304 or SUS316 may be used. In addition, in a case where elastic support parts 81 and 82 are made of magnetic material, stainless steel plates such as SUS301 may be used. As the material for elastic support parts 81 and 82, it is known that a magnetic material (for example, SUS301) is more durable and cheaper than a non-magnetic material (such as SUS304 and SUS316). Elastic support parts 81 and 82 are made of SUS301 in the present embodiment.

Elastic support parts 81 and 82 support movable body 20 such that movable body 20 does not come into contact with fixed body 50 in any of the non-reciprocating and reciprocating states of the movable body 20. As long as elastic support parts 81 and 82 elastically support movable body 20 in a manner that allows its vibration, they may be constituted by any suitable material or structure.

Elastic support parts 81 and 82 are a plurality of plate-shaped spiral springs that are flat when they are in a normal state. Each of elastic support parts 81 and 82 is configured such that arc-shaped deformable arm parts 804 extend radially outward at equal intervals from the outer edge of annular plate-shaped inner peripheral part 802, and annular plate-shaped outer peripheral fixed part 806 is connected to the end of the deformable arm parts 804.

Inner peripheral part 802 has a shape disposed on the joint surfaces of spring connection parts 224 and 244 of sleeves 22 and 24, and has approximately the same outer diameter as the outer diameter of the joint surfaces of spring connection parts 224 and 244. Deformable arm part 804, which is elastically deformable, is joined to outer peripheral fixed part 806 at one end and to inner peripheral part 802 at the other end, thereby connecting outer peripheral fixed part 806 with inner peripheral part 802.

Inner peripheral parts 802 of elastic support parts 81 and 82 are joined to both ends (spring connection parts 224 and 244) separated in the axial direction (reciprocation direction) of movable body 20. In addition, elastic support parts 81 and 82 are disposed such that the outer peripheral fixed part 806 sides protrude radially outward (radial direction) at both ends of movable body 20.

Outer peripheral fixed part 806, provided with a notch formed on the outer peripheral edge thereof, is clamped by both opening edges of coil holding part 52 and case 10, with the range formation protrusion part (positioning piece part) 54 of coil holding part 52 engaged with the notch.

Specifically, in elastic support part 81, outer peripheral fixed part 806 is clamped and fixed by annular upper end surface 527a of flange part 527 and pressing part 128 of lid part 17, in the case 10. Upper end surface 527a refers to the end surface on the upper side (one side), excluding range formation protrusion part 54 on the upper side (one side) of flange part 527.

In addition, in lower elastic support part 82, outer peripheral fixed part 806 is fixed to the lower end of coil holding part 52 on the radially outer side compared to movable body 20 in actuator 1. Specifically, outer peripheral fixed part 806 of elastic support part 82 is fixed to a portion, excluding range formation protrusion part 54, in annular lower end surface 528a of lower flange part 528, which forms the lower end of coil holding part 52.

Outer peripheral fixed part 806 of elastic support part 81 is fixed to a portion, excluding range formation protrusion part 54, in annular upper end surface 527a of upper flange part 527, which forms the upper end of coil holding part 52 (see FIG. 2). Details of the configuration of coil holding part 52 will be described later.

In the case 10, outer peripheral fixed part 806 of elastic support part 82 is clamped and fixed by annular lower end surface 528a of flange part 527 and step part 118 provided at the peripheral edge of bottom part 114. Lower end surface 528a refers to the end surface on the upper side (the other side), excluding range formation protrusion part 54 in flange part 528 on the lower side (the other side).

In this manner, in actuator 1, movable body 20 including output shaft part 25 is movably supported by elastic support parts 81 and 82 at both end portions in the vibration direction (axial direction). Thus, the straightness of movable body 20 in the movement direction is further ensured.

Note that, damping parts (dampers) 810 may be mounted on elastic support parts 81 and 82. Damping part 810 suppresses the resonance peak caused by elastic support parts 81 and 82 and generates stable vibrations over a wide range. In a case where movable body 20 supported via elastic support parts 81 and 82 is disposed with the central axis shifted, i.e., an axis deviation, in coil holding part 42, damping part 810 can adjust it such that movable body 20 moves in a suitable manner. Damping part 810 is preferably disposed by inserting an elastomer between the bridge portion of the elastic support part 81 serving as a leaf spring, and the outer peripheral part 806 and the deformation arm 804, such that it makes contact with both. Damping part 810 is preferably attached to elastic support part 81 in a plurality of places without being fixed thereto. Damping part 810 attenuates the sharp spring resonance in elastic support parts 81 and 82, thus preventing increase in the vibration difference due to the significant increase of the vibration near the resonance frequency.

### Fixed Body 50

As illustrated in FIG. 2, fixed body 50 holds coils 61 and 62 and supports movable body 20 inside the coils 61 and 62 in the radial direction such that movable body 20 is movable in the moving direction (the coil axial direction, the axial direction of the movable body 20) via elastic support parts 81 and 82.

Fixed body 50 includes coil holding part 52 that holds coils 61 and 62, in addition to coils 61 and 62 and outer yoke 70.

Actuator 1 has a configuration in which substantially all of the components that generate forth feedback, such as case 10 and movable body 20 via elastic support parts 81 and 82, are connected to coil holding part 52 in addition to coils 61 and 62.

Coil holding part 52 is a cylindrical member, and holds coils 61 and 62 disposed on the outer peripheral surface while surrounding magnet 30 with inner peripheral surface 522a. In coil holding part 52, movable body 20 including magnet 30 is disposed in a movable manner. Coil holding part 52 may be formed in a bobbin shape, and in this case, coils 61 and 62 are wound around the outer periphery of the inner cylindrical holding part main body (protective wall) in coil holding part 52.

Coil holding part 52 is a cylindrical member made of resin such as phenol resin and polybutylene terephthalate (PBT). In the present embodiment, coil holding part 52 is made of a material containing a highly flame-retardant phenolic resin such as Bakelite.

With coil holding part 52 made of a material containing phenolic resin to increase flame retardancy, even when heat is generated due to Joule heat with current flowing through coils 61 and 62 held in the coil holding part, safety during driving can be improved. This material increases the dimensional accuracy and the positional accuracy of coils 61 and 62, and thus can reduce variation in characteristics in movement, reciprocation, or vibration.

Specifically, coil holding part 52 includes cylindrical holding part main body 522, flange parts 527 and 528 and central flange part 526 protruding in the radial direction from the outer periphery of holding part main body 522, terminal part 75, and range formation protrusion part 54.

Holding part main body 522 functions as a protective wall part that protects coils 61 and 62 from collision with movable body 20 disposed inside when movable body 20 is driven. The thickness of holding part main body 522 provides a strength with which even the contact of moving movable body 20 with the holding part main body does not affect coils 61 and 62 on the outer peripheral side at all.

On the outer peripheral side of holding part main body 522, coils 61 and 62 are disposed side by side in the coil axial direction between central flange part 526 and respective flange parts 527 and 528 (coil attachment parts 52b and 52c). Terminal part 75 is a conductive member that protrudes from the outer peripheral part of holding part main body 522. Holding part main body 522 sets coils 61 and 62 to surround the outer peripheral surfaces of yokes 41 and 42 of movable body 20 (the outer peripheral surfaces of magnet 30 and yokes 41 and 42) on the radially outside.

Specifically, at the outer peripheral surface of holding part main body 522, concave coil attachment parts 52b and 52c are provided. Concave coil attachment parts 52b and 52c, partitioned by central flange part 526 and flange parts 527 and 528, are open radially outward on the outer peripheral side.

Terminal parts 75 function as connector connecting parts for setting the coil windings of coils 61 and 62 and connecting to an external device. Coils 61 and 62 are connected to the external device via terminal parts 75, and thus power can be supplied to coils 61 and 62 from the external device.

Terminal part 75 is a conductive member that protrudes from the outer peripheral part of holding part main body 522. In the present embodiment, terminal part 75 is press-fitted into the outer peripheral surface of central flange part 526 disposed at the center in the movement direction at the outer periphery of holding part main body 522. Thus, terminal part 75 protrudes from the outer peripheral surface of central flange part 526.

Flange parts 527 and 528 are provided at both ends of holding part main body 522 that are separated from each other in the axial direction (that is the movement direction and the vertical direction in the present embodiment). Flange parts 527 and 528 constitute upper and lower ends of coil holding part 52.

In flange parts 527 and 528, elastic support parts 81 and 82 are fixed at the ends in the directions away from central flange part 526 (upper and lower ends in the present embodiment).

Flange part 527 includes range formation protrusion part 54 with a protruding shape that protrudes in the axial direction (upward and downward direction) at the opening end surface on one side. One opening end surface functions as a positioning receiving part that receives and positions bracket 12 via range formation protrusion part 54. Flange part 528 includes range formation protrusion part 54 with a protruding shape that protrudes in the movement direction at the other opening end surface. The other opening end surface functions as a bottom surface receiving part that receives bottom part 114 via range formation protrusion part 54.

Range formation protrusion part 54, provided at the upper and lower end portions of coil holding part 52, forms a movement range between lid part 17 and bottom part 114 and movable body 20 when coil holding part 52 is accommodated in case 10.

Range formation protrusion part 54 is a protruding side part that protrudes in the reciprocation direction (up-down direction) from each of flange parts 527 and 528. Range formation protrusion parts 54 are provided at a predetermined interval at annular upper and lower end surfaces (also referred to as “upper and lower end surfaces,” or “open end surfaces”) 527a and 528a of flange parts 527 and 528. Upper end surface 527a is an open end surface on one side, and lower end surface 528a is an open end surface on the other side.

Range formation protrusion part 54 is fitted into a notch provided in elastic support parts 81 and 82 to perform positioning of elastic support parts 81 and 82 in the radial direction. With this configuration, stable positioning of elastic support parts 81 and 82 with respect to coil holding part 52 can be performed by uniformly setting the attachment positions of elastic support parts 81 and 82 with respect to coil holding part 52 in each individual of drive unit 13. In addition, elastic support parts 81 and 82 are not fixed to the fixed body side with respect to coil holding part 52 via a plurality of components. In this manner, rotational movement in the circumferential direction and radial direction is restricted with the structure that is less affected by component tolerances, and thus variations in elastic support parts 81 and 82 can be reduced, thereby achieving stable characteristics as a product.

Coil holding part 52 is accommodated in case 10 with range formation protrusion part 54 of the upper and lower end surfaces fitted to respective opposing portions of the edge part of bracket 12 and the inner peripheral edge part of bottom part 114, and is fixed to the edge part of bracket 12 and the edge part of bottom part 114.

### Coils 61 and 62

Coils 61 and 62 generate a magnetic field through energization, and move movable body 20 in the axial direction of coils 61 and 62 (the magnetization direction of magnet 30) as the movement direction through the electromagnetic interaction with magnet 30. Coils 61 and 62 are disposed on the outside of movable body 20 in the radial direction. Coils 61 and 62 together with magnet 30 constitute a magnetic circuit similar to a voice coil motor.

Coils 61 and 62 are disposed in coil attachment parts 52b and 52c. In the present embodiment, coils 61 and 62 are disposed at positions facing yokes 41 and 42 in a direction orthogonal to the reciprocation direction.

Coils 61 and 62 are held by coil holding part 52 such that the longitudinal center position in the coil axial direction (reciprocation direction) is approximately the same position (including the same position) in the reciprocation direction as the longitudinal center position of movable body 20 in the reciprocation direction (the center position of magnet 30 in the reciprocation direction). Coils 61 and 62 of the present embodiment are wound in opposite directions such that current flows in opposite directions when energized. Coils 61 and 62 are fixed by bonding or the like within the concave coil attachment parts 52b and 52c, with the outer peripheral surfaces surrounded by outer yoke 70 inside case 10.

The ends of coils 61 and 62 are set at terminal parts 75 of central flange part 526. Coils 61 and 62 are connected to an external power supply part via terminal parts 75. For example, the ends of coils 61 and 62 may be connected to a DC supply part such that DC power is supplied to coils 61 and 62 from the DC supply part. This allows coils 61 and 62 to generate between the magnet and the coils a thrust in one direction along the mutual axial direction, enabling movement towards or away from each other.

Further, each of end portions of coils 61 and 62 is connected to the AC supply part, and an AC power source (AC voltage) with the same frequency as the resonance frequency of movable body 20 is supplied from the AC supply part to coils 61 and 62, for example. By the power source supply, coils 61 and 62 generate between the magnet and the coils a thrust in one direction along the mutual axial direction, enabling movement towards or away from each other. Coils 61 and 62 are supplied with a current (for example, an AC current) having a frequency equal to the resonance frequency of movable body 20.

### Outer Yoke 70

Outer yoke 70 is a cylindrical magnetic body disposed at a position surrounding the outer peripheral surface of coil holding part 52 and covering coils 61 and 62 on the outside in the radial direction. Outer yoke 70 prevents leakage of the magnetic flux from actuator 1 to the outside in the radial direction in the magnetic circuit.

Outer yoke 70 is disposed such that the longitudinal center of outer yoke 70 in the reciprocation direction is at the same height as the center of inner magnet 30 in reciprocation direction. The shielding effect of outer yoke 70 can reduce leakage of the magnetic flux to the outside of the actuator.

In addition, outer yoke 70 can increase the thrust constant and improve the electromagnetic conversion efficiency in the magnetic circuit. Together with magnet 30, outer yoke 70 has a function as a magnetic spring by using the magnetic attraction force of magnet 30. The magnetic spring can reduce stress in the case where elastic support parts 81 and 82 are mechanical springs, and can improve the durability of elastic support parts 81 and 82.

### Case 10

Case 10 includes bottomed cylindrical case main body 11 including peripheral wall part 112 and bottom part 114, and bracket 12 attached inside the opening part of case main body 11.

Case main body 11 accommodates and positions drive unit 13 inside. Notch 102 is formed in peripheral wall part 112 of case main body 11, and drive unit 13 is accommodated such that terminal 75 is positioned in notch 102. Notch 102 and terminal 75 function as positioning members when drive unit 13 is accommodated in case main body 11.

Bottom part 114 limits the movable range of movable body 20. Bottom part 114 has a function as a movable range limiting part that serves as a stopper for setting the movable range of movable body 20.

Bracket 12 is an annular body that is attached to the upper portion of drive unit 13 accommodated in case main body 11, and supports fluid ejection part 14 attached to the upper portion.

Bracket 12 ensures the movable range of output shaft part 25 (mainly the portion to which fixing part 26 and piston 16 are attached) in the movement direction.

Positioning protrusion part 124 that partially protrudes radially outward and engages with notch 102 of case main body 11 is provided at the outer peripheral part of bracket 12. Positioning protrusion part 124 functions as a positioning member for attachment to case main body 11 by engaging bracket 12 with notch 102 of case main body 11.

The case 10 has a cylindrical shape. The cylindrical shape is a shape with a height (thickness) with which a sufficient thrust can be generated in the reciprocation direction through cooperation with coils 61 and 62 facing it on the outer periphery. For example, case 10 of the present embodiment is formed in a cylindrical shape with the bottomed cylindrical case main body 11 and bracket 12, but the shape is not limited thereto and may be an elliptical cylinder shape or a polygonal columnar shape. The elliptical cylinder shape or elliptical shape in the elliptical cylinder shape in the present embodiment is an ellipse mainly composed of parallel linear portions.

### Fluid Ejection Part 14

Fluid ejection part 14 is attached to case 10 and ejects fluid (for example, air) from nozzle part 19 through the movement of movable body 20.

Fluid ejection part 14 includes chamber part 14a configured to store fluid therein and provided with diaphragm 15, and nozzle part 19 serving as a passage for the fluid. Fluid ejection part 14 takes in and out the fluid of chamber part 14a in accordance with the vibration of movable body 20 at a resonance frequency, in response to the deformation of diaphragm 15 accompanying the vibration of movable body 20, and presents a tactile sensation to the user with the fluid output from chamber part 14a. Diaphragm 15 may be made of a general rubber material as long as it is an elastically deformable material. For example, diaphragm 15 is formed of silicon rubber, ethylene propylene rubber (EPDM), or the like.

The volume of chamber part 14a changes as movable body 20 moves. Nozzle part 19 is connected to chamber part 14a via opening part 174. Fluid (for example, air) in chamber part 14a can be taken in and out through nozzle part 19, and particularly, the fluid is ejected to the outside.

Specifically, fluid ejection part 14 includes lid part 17 with a lidded cylindrical shape making up chamber part 14a and including nozzle part 19, diaphragm 15 disposed to close the inside of lid part 17, and annular ejection wall part 18 that sandwiches diaphragm 15 together with lid part 17.

Ejection wall part 18 is fixed to bracket 12 and ensures the movable range of output shaft part 25 (specifically, piston 16 attached to output shaft part 25) in the vibration direction. Ejection wall part 18 holds chamber part 14a composed of lid part 17 and diaphragm 15 by clamping diaphragm 15 together with lid part 17. Ejection wall part 18 may be referred to as an air bracket, and formed of the same resin as piston 16 and lid part 17, such as ABS.

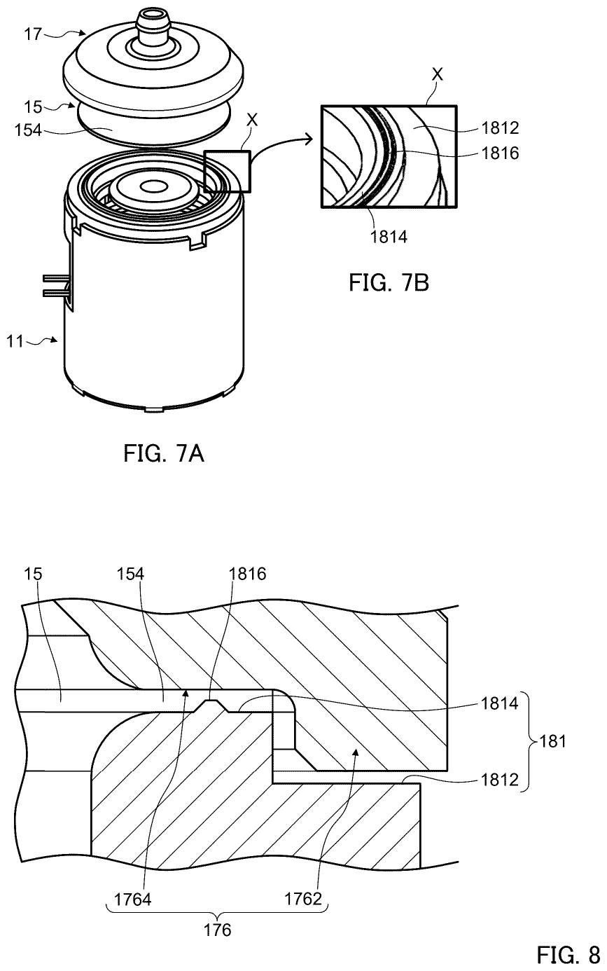

FIG. 7A is a perspective view illustrating a configuration of an upper edge part of an ejection wall part in the actuator, FIG. 7B is an enlarged view of a X portion in FIG. 7A, and FIG. 8 is a cross-sectional view illustrating a configuration of the X portion in FIG. 7.

Step part 181 is provided on the upper surface of ejection wall part 18 such that the inner peripheral part protrudes, and outer peripheral part 154 of diaphragm 15 is joined a clamping state by the step part 181 and the step part 176 of the lid part 17. Outer peripheral part 154 of diaphragm 15, particularly the outer peripheral edge part, may be bent to enhance the airtightness between step parts 176 and 181.

At step part 181 of ejection wall part 18, inner peripheral part 1814 is formed with an upper end portion higher on lid part 17 side than outer peripheral part 1812 in the annular upper opening part. Inner peripheral part 1814 and outer peripheral part 1812 constitute a step. This step engages with the step of step part 176 provided at the lower end of the cylindrical main body of lid part 17 with the outer peripheral edge part of diaphragm 15 therebetween.

In step part 181, outer peripheral part 154 of diaphragm 15 is disposed on inner peripheral part 1814 of the upper opening part of ejection wall part 18, and the lower end portion of lid part 17 is disposed on outer peripheral part 154.

With a structure in which outer peripheral part 154 of diaphragm 15 is clamped between ejection wall part 18 and lid part 17, diaphragm 15 can be sandwiched at inner peripheral parts 1764 and 1814 of step parts 176 and 181, and they can be joined to each other with outer peripheral parts 1762 and 1812 located at height positions different from the clamping height.

Thus, in actuator 1, the position shift at the clamping portion of diaphragm 15 is less likely to occur, and the airtightness can be maintained high by clamping with step parts 176 and 181.

Further, annular protrusion part 1816 that presses diaphragm 15 over the entire circumference is provided to at least one of inner peripheral parts 1764 and 1814 that clamp diaphragm 15. When inner peripheral parts 1764 and 1814 clamp diaphragm 15, annular protrusion part 1816 presses the outer peripheral part of diaphragm 15 over the entire circumference to deform the outer peripheral part. Thus, not only the prevention of the position shift of diaphragm 15, but also stabilization of the behavior of movable body 20 itself can be achieved. Note that, annular protrusion part 1816 may be provided at inner peripheral part 1764 of step part 176 of lid part 17.

Diaphragm 15, together with lid part 17, constitutes chamber part 14a that communicates with nozzle part 19. Chamber part 14a, attached to ejection wall part 18, suctions and ejects internal air through the movement of diaphragm 15.

Diaphragm 15 is disposed between ejection wall part 18 and lid part 17 in a state of partitioning both internal spaces in the vibration direction.

Piston 16 is fixed to a central portion of the lower surface of diaphragm 15. The center of diaphragm 15 and the center of piston 16, i.e., the center of output shaft part 25, are disposed on the same axis. Piston 16 is formed of a resin such as ABS, and includes a small-diameter portion and large-diameter portion 162 that is brought into contact with the central portion of diaphragm 15, for example. Large-diameter portion 162 presses diaphragm 15 to deform diaphragm 15 along the inner surface of lid part 17 that faces large-diameter portion 162. Thus, diaphragm 15 can eject the fluid in chamber part 14a without waste by deforming and crushing the space in chamber part 14a.

Thus, diaphragm 15 is provided to be displaced when vertically pushed up at the center by the movement of output shaft part 25, and diaphragm 15 is configured to be able to move as much as possible, thereby making it possible to achieve high output. Note that, when outputting the fluid at a high power, it is desirable that the load on diaphragm 15 is as small as possible.

Along with the movement of movable body 20, diaphragm 15 is displaced with the maximum amplitude such that the fluid is strongly output and a high tactile sensation is imparted.

Further, since the fluid is ejected in the same direction as the deformation direction of diaphragm 15, i.e., the direction upward of the central portion of the diaphragm, diaphragm 15 is not subjected to a load in a flat shape with its own weight in a state where diaphragm 15 is not pushed up, and thus a mechanical load can be suppressed.

Disk-shaped top surface part 172 of lid part 17 is the top surface part of actuator 1 in the present embodiment, and is disposed parallel to movable body 20 with a predetermined gap in the reciprocation direction of movable body 20. Note that lid part 17 is a part of fluid ejection part 14 and is formed of a resin such as ABS, and nozzle part 19 is provided upright at the central portion of top surface part 172. Nozzle part 19 is formed of a resin such as ABS together with top surface part 172.

### Operation of Actuator 1

FIG. 9 is a diagram for describing an operation of an actuator of Embodiment 1 according to the present invention.

An operation of actuator 1 will be described with reference to FIG. 9 with an exemplary case in which the front surface 30a side of magnet 30 on one side in the magnetization direction (the upper side in the present embodiment) is the S pole, and the back surface 30b side of magnet 30 on the other side in the magnetization direction (the lower side in the present embodiment) is the N pole.

In actuator 1, movable body 20 is considered to correspond to a mass portion in a vibration model of a spring-mass system, and thus, when the resonance is sharp (has a steep peak), the steep peak can be suppressed by damping the reciprocating motion, for example. Once the vibration is damped, the resonance becomes less sharp, and the maximum amplitude value and the maximum movement amount of movable body 20 at the time of resonance do not vary, and thus the vibration with a suitable and stable maximum movement amount is output, for example.

Magnetic flux flow mf is formed such that it is emitted from the back surface 30b side of magnet 30 and radiated from yoke 42 to the coil 62 side so as to enter magnet 30 through outer yoke 70 from yoke 41 on the upper side of magnet 30 via coil 61.

Therefore, when energized as illustrated in FIG. 9, Lorentz force in the-f direction is generated in coils 61 and 62 according to Fleming's left-hand rule through the interaction between the magnetic field of magnet 30 and the current flowing in coils 61 and 62.

The Lorentz force in the f direction is orthogonal to the direction of the magnetic field and the direction of the current flowing through coils 61 and 62. Coils 61 and 62 are fixed to fixed body 50 (coil holding part 52), and thus a force opposite to the Lorentz force (in the-f direction) is applied to movable body 20 including magnet 30 as thrust in the f direction according to the law of action and reaction. Movable body 20 with magnet 30 moves in the F direction, i.e., toward the bottom part 114 side (the bottom surface of case main body 11).

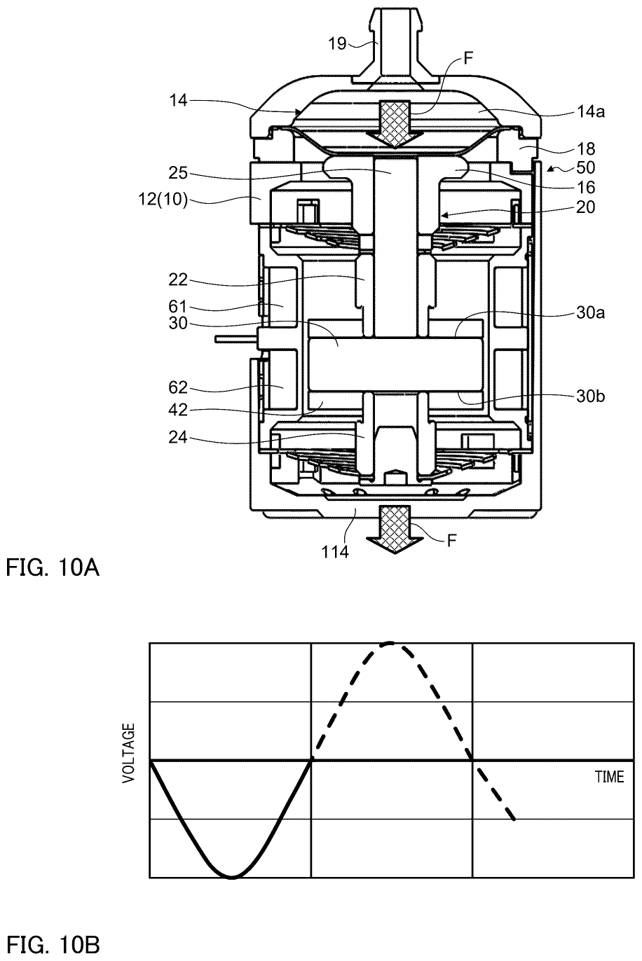

As illustrated in FIGS. 10A and 10B, output shaft part 25 moves in the F direction, i.e., toward the bottom part (bottom surface of case main body 11), and diaphragm 15 joined via piston 16 also moves in the F direction. In this manner, chamber part 14a can take in fluid at the maximum capacity by the maximum amplitude of movable body 20.

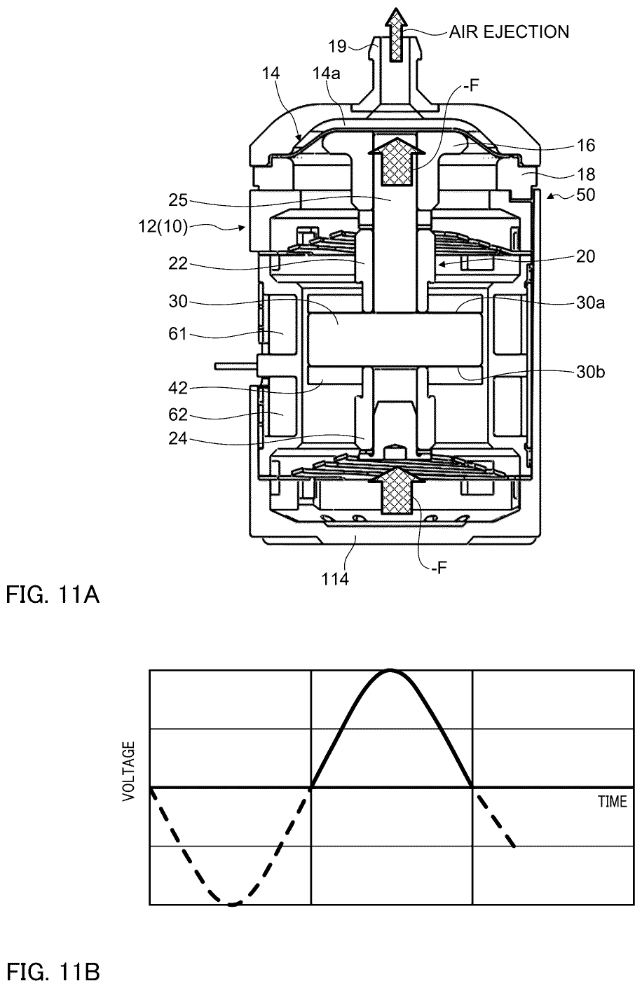

On the other hand, when the energization direction of coils 61 and 62 is switched to the opposite direction and coils 61 and 62 are energized, Lorentz force in the opposite f direction is generated. Due to the generation of this Lorentz force in the f direction, a force opposite to the Lorentz force in the f direction generated at movable body 20 as a thrust (a thrust in the-f direction), and movable body 20 moves in the-F direction, i.e., to the top surface side of lid part 17 of fixed body 50 as illustrated in FIG. 11.

As a result, output shaft part 25 also moves in the-F direction, i.e., toward lid part 17, and diaphragm 15 joined via piston 16 also moves in the-F direction, thereby contracting the inside of chamber part 14a and ejecting the captured air. As illustrated in FIGS. 11A and 11B, it is driven at the maximum amplitude to eject fluid (air).

As described above, in actuator 1, by moving movable body 20 to only one of lid part 17 side or bottom part 114 side, diaphragm 15 is varied via output shaft part 25 in response to the user's operation, and the fluid is ejected to the outside, thereby presenting the so-called aerial tactile sensation to the user.

Further, it is also possible to supply current alternately in the opposite direction to coils 61 and 62 to cause reciprocation or vibration, and to eject the fluid to the outside through the drive corresponding to the movement of movable body 20 in response to the operation of the user.

In addition, during the non-driving state (non-vibrating period) with no energization in actuator 1, magnetic attraction forces act between magnet 30 and outer yoke 70, thus achieving a function of a magnetic spring. Movable body 20 returns to its original position with the magnetic attraction forces generated between magnet 30 and outer yoke 70 and the restoring force of returning to the original shape of elastic support parts 81 and 82.

Actuator 1 is driven by an AC wave input from the power supply part (control part) to the pair of coils 61 and 62. Specifically, the energization direction of the pair of coils 61 and 62 is periodically switched, and the thrust in the-F direction on the top surface part 172 side of lid part 17 and the thrust in the F direction on the bottom part 114 side alternately act on movable body 20 as illustrated in FIG. 9. Thus, movable body 20 vibrates in the vibration direction. Thus, movable body 20 can perform force feedback by moving in the movement direction or the vibration direction and ejecting the fluid. In this manner, it is possible to easily produce actuator 1 at low cost with easy-to-use detection and tactile feedback functions.

### Driving Principle of Actuator 1

The driving principle of actuator 1 will be briefly described. In actuator 1 of the present embodiment, when the mass of movable body 20 is m [kg] and the spring constant of the spring (elastic support parts 81 and 82, which are springs) is Kₛₚ, movable body 20 vibrates at resonance frequency Fᵣ [Hz] calculated by the following Equation 1 with respect to fixed body 50.

$${F}_{r} = \frac{1}{2 π} \sqrt{\frac{{K}_{sp}}{m}} \qquad ( Equation 1 )$$

Movable body 20 is considered to constitute the mass portion in a vibration model of a spring-mass system. Therefore, when an AC wave with a frequency equal to the resonance frequency Fᵣ of movable body 20 is input into the coil (pair of coils 61 and 62), movable body 20 enters a resonance state. That is, by inputting an AC wave with a frequency substantially equal to resonance frequency Fᵣ of movable body 20 into coil (pair of coils 61 and 62) from the power supply part, it is possible to efficiently vibrate movable body 20.

The motion equation and the circuit equation illustrating the driving principle of actuator 1 are described below. Actuator 1 is driven based on the motion equation represented by the following Equation 2 and the circuit equation represented by the following Equation 3.

$$m \frac{{d}^{2} x ( t )}{{dt}^{2}} = {K}_{f} i ( t ) - {K}_{sp} x ( t ) - D \frac{dx ( t )}{dt} \qquad ( Equation 2 )$$

$$m : Mass [ kg ]$$

$$x ( t ) : Displacement [ m ]$$

$${K}_{f} : Thrust constant [ N / A ]$$

$$i ( t ) : Current [ A ]$$

$${K}_{sp} : Spring constant [ N / m ]$$

$$D : Damping coefficent [ N / ( m / s ) ]$$

$$e ( t ) = Ri ( t ) + L \frac{di ( t )}{dt} + {K}_{e} \frac{dx ( t )}{dt} \qquad ( Equation 3 )$$

$$e ( t ) : Voltage [ V ]$$

$$R : Resistance [ Ω ]$$

$$L : Inductance [ H ]$$

$${K}_{e} : Back electromotive force constant [ V / ( rad / s ) ]$$

That is, mass m [kg], displacement x(t) [m], thrust constant K_{f} [N/A], current i(t) [A], spring constant Kₛₚ [N/m], damping coefficient D [N/(m/s)], and the like in actuator 1 can be appropriately changed within a range that satisfies Equation 2. Further, voltage e(t) [V], resistance R [Ω], inductance L [H], and back electromotive force constant Kₑ [V/(rad/s)] can be appropriately changed within a range that satisfies Equation 3.

Thus, in actuator 1, when coils 61 and 62 are energized with an AC wave corresponding to resonance frequency Fᵣ determined by mass m of movable body 20 and spring constant Kₛₚ of elastic support parts 81 and 82, which are leaf springs, a large vibration output can be efficiently obtained.

Further, actuator 1 satisfies Equations 2 and 3, and is driven by a resonance phenomenon using the resonance frequency represented by Equation 1. Thus, actuator 1 can be driven with low power consumption, i.e., movable body 20 can be linearly reciprocated with low power consumption. Further, by increasing the damping coefficient D, it is possible to generate vibrations over a high band.

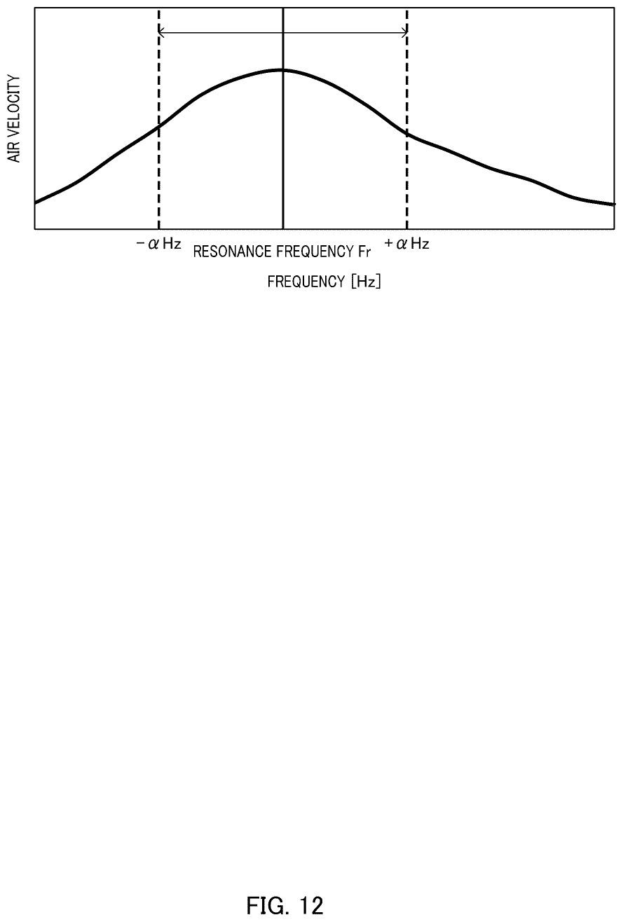

FIG. 12 is a diagram illustrating a relationship between the resonance frequency of the current supplied to the coil of actuator 1 and the velocity of the fluid ejected from the fluid ejection part.

The current supplied to coils 61 and 62 is, as illustrated in FIG. 12, a current with a frequency equal to the resonance frequency (also referred to as “resonance frequency of movable body 20”) Fᵣ determined by the mass m of movable body 20 and the spring constant Kₛₚ of elastic support parts 81 and 82, which are leaf springs, or a current with a frequency close to the resonance frequency (in the vicinity of the resonance frequency). The frequency close to the resonance frequency is a frequency in a range of minus a to plus a of resonance frequency Fᵣ, and a is preferably 50 or 30, for example. That is, the frequency close to the resonance frequency is preferably a frequency in a range of minus 50 Hz to plus 50 Hz with respect to the resonance frequency of movable body 20. More preferably, the frequency close to the resonance frequency is a frequency in a range of minus 30 Hz to plus 30 Hz (the same as plus 30 Hz to minus 30 Hz of the resonance frequency) of the resonance frequency of movable body 20.

By supplying current of a frequency within the above-mentioned range, movable body 20 vibrates and the velocity of the fluid ejected from actuator 1 (specifically, fluid ejection part 14) has a desired suitable velocity. Thus, with actuator 1 (the same applies to non-contact tactile presentation system 300 and actuator 1A in Variation 1 described later) of the present embodiment, a non-contact tactile sensation with a suitable operation feeling can be presented to the user without contaminating the fingers by ejecting air as a fluid.

According to the present embodiment, plate-like elastic support parts 81 and 82 are disposed above and below (in the vibration direction) movable body 20. Thus, actuator 1 stably drives movable body 20 in the up-down direction and, at the same time, can efficiently distribute the magnetic flux of pair of coils 61 and 62 from upper and lower elastic support parts 81 and 82 of magnet 30. Thus, it is possible to realize a high-output vibration as actuator 1.

### Variations

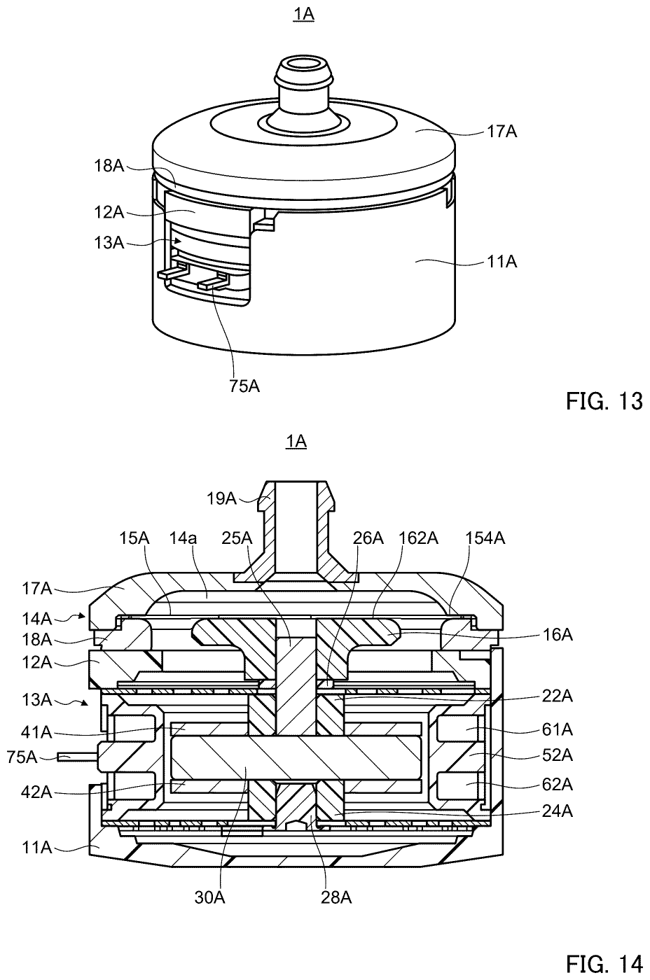

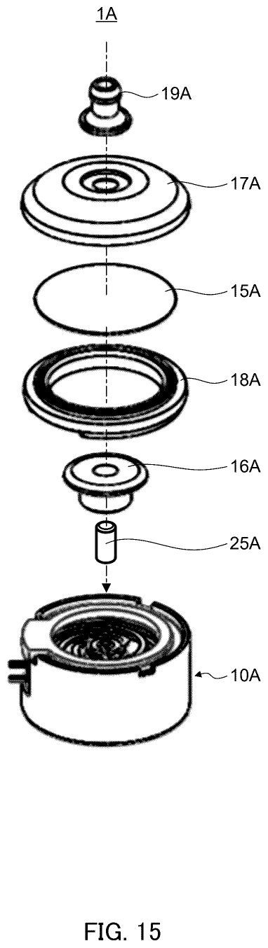

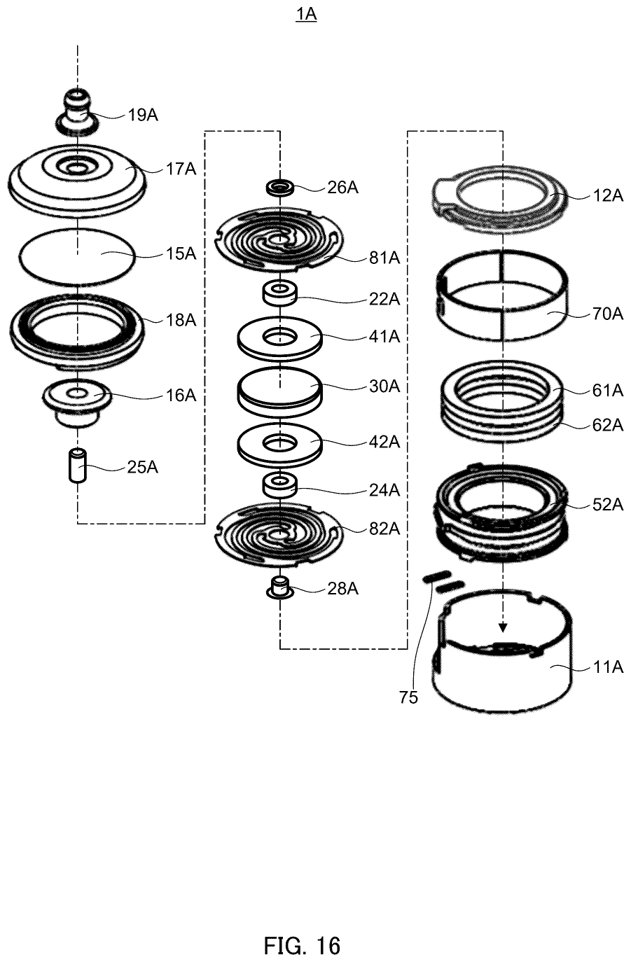

FIG. 13 is a perspective view illustrating a variation of the actuator, FIG. 14 is a longitudinal cross-sectional view illustrating a main part configuration of the variation of the same actuator, and FIG. 15 is a partially exploded view illustrating a main part configuration of a fluid ejection part in the variation of the same actuator. FIG. 16 is an exploded view of Variation 1 of the actuator.

Actuator 1A is, for example, an actuator that presents a tactile sensation to the user in a non-contact manner as with actuator 1, and transmits, as a tactile sensation and a force sensation to the user, the ejection of fluid through the reciprocation of movable body 20A in response to the user's non-contact operation on the operation part.

Actuator 1A has a different vertical and horizontal configuration of case 10 compared to actuator 1, but the basic configuration is the same. Accordingly, in actuator 1A, the same components as those in actuator 1 will be described with “A” attached to the same names and the same reference numerals, and the description will be omitted, and only the differences will be described. That is, as illustrated in FIGS. 13 to 16, actuator 1A includes drive unit 13A accommodated inside case 10A including case main body 11A and bracket 12A, and fluid ejection part 14A. When drive unit 13A is driven, fluid ejection part 14A ejects to the outside the fluid, which is air in this case.

As with drive unit 13, drive unit 13A has a configuration in which movable body 20A and the main portion of fixed body 50A including coil holding part 52A are connected by elastic support parts 81A and 82A, and is accommodated within case 10A.

Actuator 1A includes magnet 30A in movable body 20 and coils 61A and 62A in fixed body 50A. Movable body 20A reciprocates in a straight line direction (axial direction) along the axial direction (up-down direction) of case 10A through the cooperation (electromagnetic interaction) between energized coils 61A and 62A and magnet 30A.

Output shaft part 25A provided in movable body 20A connects movable body 20A and fluid ejection part 14A.

In actuator 1A, fluid ejection part 14A is provided together with a part of case 10A, and movable body 20A is supported in a reciprocally movable manner with respect to fixed body 50A via elastic support parts 81A and 82A bridged between movable body 20A and fixed body 50A in case 10A.

Specifically, in actuator 1A, drive unit 13A includes output shaft part 25A, magnet 30A, a pair of yokes 41A and 42A, and a pair of sleeves 22A and 24A, and fixed body 50A includes a pair of annular coils 61A and 62A and outer yoke 70A.

Fluid ejection part 14A performs in the same manner as fluid ejection part 14 in accordance with the deformation of diaphragm 15A due to the vibration of movable body 20A caused by the supply of a current with a frequency equal to the resonance frequency of movable body 20A to coils 61A and 62A. That is, along with the deformation of diaphragm 15A, the fluid in chamber part 14a is taken in and out in accordance with the resonance vibration of movable body 20A, and thus the fluid (for example, air) output from chamber part 14a hits the user. Thus, actuator 1A presents a tactile sensation to the user.

Note that actuator 1A has the same configuration as actuator 1 and has the same effects.

In addition, actuator 1A has a smaller thickness of each member in the axial direction and a larger dimension in the radial direction. In particular, in piston 16A joined to diaphragm 15 that varies the capacity of chamber part 14a, the diameter (the diameter of pressing surface 162A of the large-diameter portion) of the surface joined to diaphragm 15 can be increased. When diaphragm 15A is pressed and deformed with large-diameter piston 16A, it presses diaphragm 15A by moving in a direction orthogonal to diaphragm 15A at the center of diaphragm 15A. Thus, pressing surface 162A can press diaphragm 15A at its central portion with the maximum amplitude of movable body 20A, thereby displacing diaphragm 15A more effectively. Thus, it is possible to achieve actuator 1A that can eject fluid through stable and suitable vibration even with a small axial length and a low profile.

### Non-Contact Tactile Presentation System 300

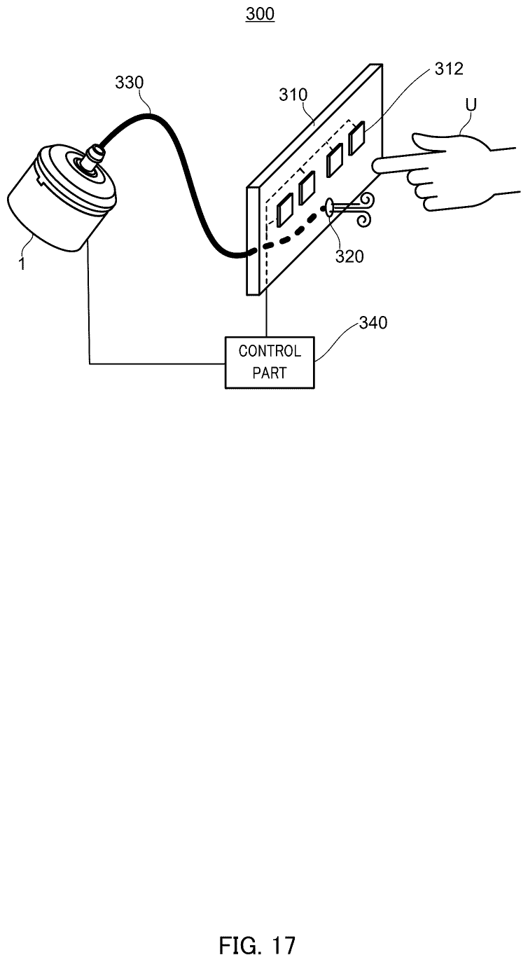

FIG. 17 is a schematic diagram illustrating a main part configuration of non-contact tactile presentation system 300 including actuator 1. Non-contact tactile presentation system 300 includes actuator (vibration presentation apparatus) 1, operation panel 310, ejection hole 320, connection pipe 330, and control part 340.

In non-contact tactile presentation system 300, non-contact operation part 312 and ejection hole 320 are provided in operation panel (here, non-contact operation panel) 310. Non-contact operation part 312 is connected to control part 340, and when a user operates, that is, when the user's finger approaches non-contact operation part 312, the information is output to control part 340. Ejection hole 320 is connected to nozzle part 19 of actuator 1 via connection pipe 330.

Non-contact tactile presentation system 300 uses a well-known non-contact sensor (not illustrated) as non-contact operation part 312. The non-contact sensor detects a finger of a user close to non-contact operation part 312, and actuator 1 moves based on this detection. The non-contact sensor is a capacitance sensor, an ultrasonic sensor, a light sensor, or the like. A light sensor or the like can detect the reflection light from a detection target by receiving the reflection light using infrared light. For example, desirably, the detection of the detection target such as light is performed at a distance of 20 mm to 50 mm, 30 mm to 50 mm, or 20 mm to 25 mm. Actuator 1 can eject fluid and present a tactile sensation to the users separated by these detection distances.

Control part 340 drives actuator 1 in response to a non-contact operation of finger U of the user on non-contact operation part 312, for example. Control part 340 is connected to non-contact operation part 312 and actuator 1, and includes a CPU, a RAM, a ROM, a drive circuit for the actuator, and the like, for example. Control part 340 energizes coils 61 and 62 of actuator 1 in accordance with a signal input from the non-contact sensor, and generates an electromagnetic interaction with magnet 30. When actuator 1 is driven and movable body 20 is moved, air as a fluid is sent to ejection hole 320 via connection pipe 330 and blown onto finger U of the user.

Thus, it is possible to provide the user with a tactile sensation of a non-contact operation in response to the non-contact operation. Thus, by appropriately arranging nozzle part 19 in a configuration suitable for the non-contact tactile sensation presentation via connection pipe 330 and ejection hole 320, it is possible to suitably impart the operation feeling of non-contact operation. The distance between non-contact operation part 312 and ejection hole 320 and finger U of the user can be set to an appropriate distance, e.g., 30 to 50 mm.

### Overview

Actuators 1 and 1A include fixed bodies 50 and 50A including coils 61, 61A, 62, and 62A; movable bodies 20 and 20A including magnets 30 and 30A disposed on the radially inner side of coils 61, 61A, 62, and 62A and magnetized in the axial direction of coils 61, 61A, 62, and 62A; and fluid ejection parts 14 and 14A. In addition, in actuators 1 and 1A, flat plate-like elastic support parts 81, 81A, 82, and 82A elastically hold movable bodies 20 and 20A for moving diaphragms 15 and 15A of fluid ejection parts 14 and 14A in a movable manner at both end portions separated from each other in the movement direction, which is the coil axis direction.

Diaphragms 15 and 15A are deformed along with the vibration of resonating movable bodies 20 and 20A when coils 61, 61A, 62, and 62A are supplied with the power source of the resonance frequency set by mass m [kg] of movable bodies 20 and 20A and spring constant Kₛₚ [N/m] of elastic support parts 81, 81A, 82, and 82A, which are leaf springs. Thus, a fluid corresponding to the resonance vibration of the movable body is ejected toward the user, thereby providing the user with a non-contact tactile sensation.

Further, elastic support parts 81, 81A, 82, and 82A serving as leaf springs also ensure the straightness of the movement of movable bodies 20 and 20A in the movement direction, and can stably and smoothly drive diaphragms 15 and 15A with high amplitude.

With actuators 1 and 1A, air (fluid) can be ejected more suitably, and thus a stable and strong tactile sensation can be realized. By presenting a non-contact tactile sensation, it is possible to present a tactile sensation with a suitable operation feeling to the user without contamination of the fingers. Thus, by using non-contact operation panel 310 in combination, it is possible to realize an operation panel with a good operation feeling even in a non-contact manner.

Further, diaphragms 15 and 15A are joined to output shaft parts 25 and 25A of movable bodies 20 and 20A, which move in a direction perpendicular to diaphragms 15 and 15A via pistons 16 and 16A at the central portions of diaphragms 15 and 15A. In this manner, diaphragms 15 and 15A are displaced such that the central portion is vertically pushed up, thus achieving the maximum amplitude. As a result, the fluid is strongly output through nozzle part 19, thus providing a high tactile sensation.

Diaphragm 15 has outer peripheral part 154 clamped between lid part 17 and step parts 176 and 181 of ejection wall part 18. Outer peripheral part 154 of diaphragm 15 is held in a hermetically sealed state by being clamped between inner peripheral parts 1814 and 1764, which have different heights with respect to outer peripheral parts 1762 and 1812, at step parts 176 and 181. Further, diaphragm 15 is clamped between lid part 17 and ejection wall part 18 in a state in which the entire circumference of outer peripheral part 154 is pressed by annular protrusion part 1816. Note that diaphragm 15A is also clamped in the same manner as diaphragm 15, between step parts 176 and 181 of lid part 17A and ejection wall part 18A in actuator 1A.

In this manner, it is possible to prevent the position shift of diaphragm 15 and stabilize the behavior of movable body 20. Further, since diaphragm 15 is clamped and adhesively fixed at step parts 176 and 181, it is possible to prevent leakage of the fluid (air) inside.

With the structure that ensures the fixation of diaphragm 15 while preventing air leakage, it is possible to impart a stable non-contact tactile sensation.

In addition, terminal 75 protruding outward provided on coil holding part 52 increases the ease of the setting and soldering of coil wires of the coils, thereby facilitating the connection between external devices and coils 61 and 62. Further, since magnet 30 is provided on movable body 20, it is possible to achieve a device with a high amplitude for achieving a strong tactile sensation expression in comparison with a case where a coil is provided on movable body 20 in the above configuration, which also makes it easy to ensure reliability in that case. Further, since coils 61 and 62 are configured to surround magnet 30, it is possible to achieve high output and high efficiency in the magnetic circuit.

Further, non-contact tactile presentation system 300 provided with the above-described configuration includes operation panel 310, which is an operation apparatus including an operation part that detects a non-contact operation of a user, and control part 340, which vibrates movable body 20 by energizing coils 61 and 62 in accordance with the detected non-contact operation. Ejection hole 320, which ejects the fluid output from chamber part 14a toward the user (finger U), is provided in operation panel 310. Thus, it is possible to provide a tactile sensation in a non-contact manner in response to a non-contact operation by the user. Further, ejection hole 320 is set at operation panel 310 in a manner suitable for tactile sensation presentation to thereby present an excellent non-contact tactile sensation.

The embodiments disclosed here are in all respects to be considered illustrative and not restrictive. The scope of the invention is indicated by the claims, not by the above description, and is intended to include all modifications within the meaning and scope equivalent to the claims.

The above description is an embodiment of the present invention. The above description is an illustration of a suitable embodiment of the invention, and the scope of the invention is not limited thereto. In other words, the above description of the configuration of the device and the shape of each part is an example, and it is clear that various changes and additions to these examples are possible within the scope of the invention.

This application is entitled to and claims the benefit of Japanese Patent Application No. 2022-127460 filed on Aug. 9, 2022, the disclosure each of which including the specification, drawings and abstract is incorporated herein by reference in its entirety.

### INDUSTRIAL APPLICABILITY

The actuator according to the present invention has a feedback function of presenting a non-contact tactile sensation with a suitable operation feeling without contaminating a finger through ejection of a fluid, and is useful as an actuator that presents a tactile sensation or the like in a non-contact manner.

### REFERENCE SIGNS LIST

1 Actuator
10 Case
11 Case main body
12 Bracket
13 Drive unit
14 Fluid ejection part
15 Diaphragm
16 Piston
17 Lid part
18 Ejection wall part
20 Movable body
20a Outer peripheral surface
22, 24 Sleeve
23 Through-hole
25 Output shaft part
26 Fixing part
28 Spring connection part
30 Magnet
30a Surface
30b Back surface
41, 42 Yoke
50 Fixed body
52 Coil holding part
52b, 52c Coil attachment part
54 Range formation protrusion part
61, 62 Coil
70 Outer yoke
75 Terminal
81, 82 Elastic support part (elastic part)
102 Notch
112 Peripheral wall part
114 Bottom part
115 Opening part
118 Step part
124 Positioning protrusion part
126 Central opening
128 Pressing part
172 Top surface part
222 Joining part
224, 244 Spring fixing part
242 Joining part
282 Insertion part
284 Flange
300 Non-contact tactile presentation system
310 Non-contact operation panel
312 Non-contact operation part
320 Ejection hole
412 Opening part
422 Opening part
522 Holding part main body
522a Inner peripheral surface
526, 527 Flange part
527a Upper end surface
528 Flange part
528a Lower end surface
802 Inner peripheral part
804 Deformation arm part
806 Outer peripheral fixing part
810 Damping part

1. A non-contact tactile presentation apparatus, comprising:
a movable body including a magnet;
an elastic part configured to support the movable body in a manner allowing vibration;
a fixed body including a coil configured to vibrate the movable body through an electromagnetic interaction with the magnet by generating a magnetic field with a supply of a current of a frequency equal to a resonance frequency of the movable body; and
a fluid ejection part including a chamber part that includes a diaphragm and is configured to store inside a fluid, the fluid ejection part being configured to present a tactile sensation using the fluid ejected from the chamber part by taking in and out the fluid in the chamber part in accordance with deformation of the diaphragm accompanying resonance vibration of the movable body.

2. A non-contact tactile presentation apparatus, comprising:
a movable body including a magnet;
an elastic part configured to support the movable body in a manner allowing vibration;
a fixed body including a coil configured to vibrate the movable body through an electromagnetic interaction with the magnet by generating a magnetic field with a supply of a current of a frequency close to a resonance frequency of the movable body; and
a fluid ejection part including a chamber part that includes a diaphragm and is configured to store inside a fluid, the fluid ejection part being configured to present a tactile sensation using the fluid ejected from the chamber part by taking in and out the fluid in the chamber part in accordance with deformation of the diaphragm accompanying vibration of the movable body.

3. The non-contact tactile presentation apparatus according to claim 1, wherein the magnet is disposed at a position away from the coil and surrounded by the coil.

4. The non-contact tactile presentation apparatus according to claim 1, wherein the elastic part elastically supports the movable body with respect to the fixed body in a plurality of portions that are separated from each other in a vibration direction such that the movable body is movable in the vibration direction.

5. The non-contact tactile presentation apparatus according to claim 3, wherein the elastic part is a leaf spring.

6. The non-contact tactile presentation apparatus according to claim 1, wherein the diaphragm is fixed to the movable body at a central portion of the diaphragm.

7. The non-contact tactile presentation apparatus according to claim 1, further comprising a nozzle disposed above the diaphragm so as to open along a deformation direction of the diaphragm and serve as a passage of a fluid to be taken in and out of the chamber part, the diaphragm being disposed such that a surface of the diaphragm is perpendicular to a vibration direction.

8. The non-contact tactile presentation apparatus according to claim 1,
wherein the fixed body includes a coil holding part formed in a cylindrical shape and configured to movably accommodate the movable body by surrounding the movable body with the coil; and
wherein the diaphragm is clamped between one opening part of the coil holding part and the fluid ejection part via a step part.

9. The non-contact tactile presentation apparatus according to claim 1,
wherein the fixed body includes a coil holding part formed in a cylindrical shape and configured to movably accommodate the movable body by surrounding the movable body with the coil; and
wherein the diaphragm is adhesively fixed between one opening part of the coil holding part and the fluid ejection part.

10. The non-contact tactile presentation apparatus according to claim 2, wherein the frequency close to the resonance frequency supplied to the coil is from plus 30 Hz to negative 30 Hz with respect to the resonance frequency.

11. A non-contact tactile presentation system, comprising:
the non-contact tactile presentation apparatus according to claim 1;
an operation apparatus including an operation part that is configured to detect a non-contact operation of a user;
a control part configured to vibrate the movable body by energizing the coil in response to a detected non-contact operation; and
an ejection hole provided in the operation apparatus and configured to eject toward the user a fluid output from the chamber part.
